(19) United States
(12) Patent Application Publication
(10) Pub. No.: US 2022/0351255 A1
(43) Pub. Date: Nov. 3, 2022

(54) System and Method for Streamlining Fundraising for Candidates

(71) Applicant: ALIQUAM DEVELOPMENT, LLC, Port Aransas, TX (US)

(72) Inventors: William C. STRIEBER, Port Aransas, TX (US); Kevin WAISFELD, Austin, TX (US)

(73) Assignee: ALIQUAM DEVELOPMENT, LLC, Port Aransas, TX (US)

(21) Appl. No.: 17/772,349

(22) PCT Filed: Oct. 28, 2020
(86) PCT No.: PCT/US20/57633

§ 371 Date: Apr. 27, 2022

Related U.S. Application Data
(60) Provisional application No. 62/926,699, filed on Oct. 28, 2019.

(51) Int. Cl. G06Q 30/02; G06Q 20/40; G06Q 20/02; G06F 3/04842; G06F 3/0481

(52) U.S. Cl. CPC G06Q 30/0279; G06Q 20/405; G06Q 20/02; G06F 3/04842; G06F 3/0481; G06Q 30/0214

(57) ABSTRACT

A method includes providing a user interface in fundraising page to a computing device of a donor, receiving a selection of a graphical element, providing a user interface presenting a donation form generated based on a second template, and receiving a donation request from the computing device. The method also includes receiving a second donation request from a second computing device presenting a second donation form. The method also includes accumulating a lump sum of the item, generating a list of information required by the campaign to comply with a rule, a law, a regulation, or some combination thereof, and transmitting the lump sum of the item and the list to a third-party account of the candidate via an application programming interface (API) and the commission to a second third-party account of the fundraiser and the second commission to a third third-party account of the second fundraiser.

### CROSS-REFERENCE TO RELATED APPLICATIONS

This application claims the benefit of U.S. Provisional Application No. 62/926,699 filed Oct. 28, 2019 and titled “System and Method for Streamlining Fundraising for Candidates,” and the provisional application is incorporated by reference herein as if reproduced in full below.

### BACKGROUND

In the political realm, an individual referred to as a “Fundraiser” raises money for one or more candidates for political office, the political offices ranging from a mere county precinct chairman to President of the United States. The Fundraiser generally takes a small percentage of the money donated (e.g., 3-5%) as a commission for the efforts.

However, a campaign must know from whom money is being donated to ensure compliance with various election laws, such as a maximum donation limits from individuals (which varies by race and by state), in some cases to ensure money is not being donated in the name of a corporation, as well as for campaign finance reporting. Further, some campaigns may elect to not take money from an otherwise eligible donor. Thus, a Fundraiser cannot just give the money to the target campaign. That money must be accompanied by a specific set of information.

If a Fundraiser is raising funds for a single candidate, the accounting issues may be relatively easy to manage; however, if a Fundraiser is raising money for many candidates, across many races, and perhaps even on different sides of the political spectrum, the accounting and reporting aspects become prohibitive.

### SUMMARY

In one embodiment, a method may include providing a user interface presenting a fundraising page to a computing device of a donor. The fundraising page includes a graphical element to enable donating to a candidate and the fundraising page is generated based on a first template. The method may also include receiving a selection of the graphical element from the computing device, providing a user interface presenting a donation form generated based on certain aspects pertaining to a political race in which the candidate is running, a government for which the political race is being held, or some combination thereof, and the donation form is generated based on a second template. The method also includes receiving a donation request from the computing device, the donation request including an amount to donate, an identity of the candidate, and a campaign associated with the candidate. The method may also include receiving a second donation request from a second computing device presenting a second donation form, the second donation request including a second amount to donate, the identity of the candidate, and the campaign associated with the candidate. The method may also include accumulating a lump sum of the amounts by at least subtracting a portion from the amount of the item and a second portion from the second amount of the item. The portion from the amount of the item may be a commission for a fundraiser associated with the donation form, and the second portion from the second amount of item may be a second commission for a second fundraiser associated with the second donation form. The method may also include generating a list of information required by the campaign to comply with a rule, a law, or both, wherein the list of information comprises at least an identity of the donor. At a certain first time, the method may also include transmitting the lump sum of the item and the list to a third-party account of the candidate via an application programming interface (API). At a certain second time, the method may also include transmitting, via the API, the commission to a second third-party account of the fundraiser and the second commission to a third third-party account of the second fundraiser.

In one embodiment, a system may include processing device communicatively coupled to a memory device storing instructions, and the processing device may execute the instructions to perform any of the operations discussed above. In one embodiments, a tangible, non-transitory computer-readable medium may store instructions that, when executed, cause a processing device to perform any of the operations discussed above.

Other technical features may be readily apparent to one skilled in the art from the following figures, descriptions, and claims.

### BRIEF DESCRIPTION OF THE DRAWINGS

For a detailed description of example embodiments, reference will now be made to the accompanying drawings in which:

FIG. 1 illustrates a high-level component diagram of an illustrative system architecture according to certain embodiments of this disclosure;

FIG. 2 illustrates an example user interface of an application that enables a fundraiser to create fundraising page and donation form according to certain embodiments of this disclosure;

FIG. 3 illustrates an example user interface of an application presenting a home page for a fundraiser according to certain embodiments of this disclosure;

FIG. 4 illustrates an example user interface of an application presenting a fundraising page to a donor according to certain embodiments of this disclosure;

FIG. 5 illustrates an example user interface of an application presenting a donation form according to certain embodiments of this disclosure;

FIG. 6 illustrates an example block diagram of various operations performed by components of the system according to certain embodiments of this disclosure;

FIG. 7 illustrates example operations of a method for enabling a donor to donate to a candidate according to certain embodiments of this disclosure;

FIG. 8 illustrates example operations of a method for upselling a fundraising page on a social media platform according to certain embodiments of this disclosure; and

FIG. 9 illustrates an example computer system.

### NOTATION AND NOMENCLATURE

Various terms are used to refer to particular system components. Different entities may refer to a component by different names — this document does not intend to distinguish between components that differ in name but not function. In the following discussion and in the claims, the terms “including” and “comprising” are used in an open-ended fashion, and thus should be interpreted to mean “including, but not limited to . . . .”Also, the term “couple” or “couples” is intended to mean either an indirect or direct connection. Thus, if a first device couples to a second device, that connection may be through a direct connection or through an indirect connection via other devices and connections.

Various terms are used to refer to particular system components. Different entities may refer to a component by different names — this document does not intend to distinguish between components that differ in name but not function. In the following discussion and in the claims, the terms “including” and “comprising” are used in an open-ended fashion, and thus should be interpreted to mean “including, but not limited to . . . .”Also, the term “couple” or “couples” is intended to mean either an indirect or direct connection. Thus, if a first device couples to a second device, that connection may be through a direct connection or through an indirect connection via other devices and connections.

The terminology used herein is for the purpose of describing particular example embodiments only, and is not intended to be limiting. As used herein, the singular forms “a,” “an,” and “the” may be intended to include the plural forms as well, unless the context clearly indicates otherwise. The method steps, processes, and operations described herein are not to be construed as necessarily requiring their performance in the particular order discussed or illustrated, unless specifically identified as an order of performance. It is also to be understood that additional or alternative steps may be employed.

The terms first, second, third, etc. may be used herein to describe various elements, components, regions, layers and/or sections; however, these elements, components, regions, layers and/or sections should not be limited by these terms. These terms may be only used to distinguish one element, component, region, layer or section from another region, layer or section. Terms such as “first,” “second,” and other numerical terms, when used herein, do not imply a sequence or order unless clearly indicated by the context. Thus, a first element, component, region, layer or section discussed below could be termed a second element, component, region, layer or section without departing from the teachings of the example embodiments. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. In another example, the phrase “one or more” when used with a list of items means there may be one item or any suitable number of items exceeding one.

Spatially relative terms, such as “inner,” “outer,” “beneath,” “below,” “lower,” “above,” “upper,” “top,” “bottom,” and the like, may be used herein. These spatially relative terms can be used for ease of description to describe one element's or feature's relationship to another element(s) or feature(s) as illustrated in the figures. The spatially relative terms may also be intended to encompass different orientations of the device in use, or operation, in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), solid state drives (SSDs), flash memory, or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

The term “Fundraiser” herein refers to the person that creates a fundraiser. The term “fundraiser” refers to raising amounts of an item (e.g., money or funds) for a candidate running a campaign through donations.

### DETAILED DESCRIPTION

The following discussion is directed to various embodiments of the disclosed subject matter. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Some embodiments include a platform that conglomerates several aspects of what Fundraisers do. In an example platform, each Fundraiser creates, from a tem plate-driven system, a fundraising page for each candidate (or multiple fundraising pages for a single candidate, each page with a different “spin”). Multiple Fundraisers may be raising funds for duplicate political candidates within the platform. The fundraising pages reside within and are web-served by the platform (in some embodiments, the fundraising pages are presented via a stand-alone application (e.g., not a webpage) installed on a computing device of a user), such that the Fundraisers need not be concerned with web hosting issues. Each fundraising page will have a “Donate Now” or similar button that enables donors to donate to campaigns using credit cards. The platform thus provides funds processing (e.g., credit card processing with www.stripe.com servers, Venmo ®, any suitable digital wallet, etc.) to collect the donations into an account, and also to save to a database information about the identity of the Fundraiser, the donor, and/or donation information for each donation received. Thus, the Fundraisers need not be concerned with the intricacies of online payment processing, and the Fundraisers need not be concerned with the accounting and book keeping aspects of the donations.

Selection of the “Donate Now” button may transfer focus from the fundraising page to a donation form that is electronically generated for a particular candidate. The donation form may be generated to abide by certain rules and/or laws for a particular race and/or a government (e.g., state, federal). For example, a candidate in Texas may be allowed to accept up to a certain maximum amount of money from one candidate, whereas a candidate in Florida may be allowed to accept up to a different maximum amount of money from one candidate. Further, the information required to be entered with a donation by a donor may be different for different races and/or states. Thus, the donation form tied to each individual fundraising page may be unique and may comply with rules and/or laws for a race and/or state.

A donor may enter the amount of money to donate in the donation form and submit a donation request including a donation amount of money, a candidate to which the donation is given, a company the donor works for, a name of the donor, an address of the donor, a phone number of the donor, demographic information of the donor (e.g., race, age, gender, etc.), and so forth. The donation request may be transmitted from a computing device of the user to the platform. The platform may receive the donation request and determine which account of the candidate to send the donation to. Further, the platform may perform certain calculations, such as determining commissions for the Fundraiser, the host of the platform, etc. Other calculations may include calculating a fee for payment processing of a third party entity that processes the transaction. The commissions and/or fees may be subtracted from the donation.

Periodically (e.g., weekly, monthly, dollar-amount triggered), the platform facilitates transferring the donations to the political candidates *along with* information that the campaign needs to ensure compliance with self-imposed rules, campaign finance laws, and campaign finance reporting. Thus, for a single period, the system may provide a lump sum to each political candidate, where the lump sum may be based on donations through or on behalf of multiple Fundraisers and/or through multiple fundraising pages. Also periodically, and not necessarily on the same period as sending money and data to the respective campaigns, the system may calculate and provide each Fundraiser the Fundraiser's lump sum commission for acquiring the donations on behalf of political candidates.

Technical advantages of the disclosed subject matter may include reducing the amount of transactions that are performed between the platform and the payment processing system. That is, since lump sums of donations for candidates are being transmitted, instead of individual amounts for each donation, fewer messages may be sent over a network. As a result, network bandwidth may be improved using the disclosed techniques.

Further, the fundraising and donation process is streamlined using the disclosed techniques. Fundraisers do not need to know the candidate finance laws, rules, and/or campaign finance reporting because the platform is programmed to ensure compliance with these various issues by providing dynamic donation forms and reporting the appropriate information to the candidates when transmitting the donations.

In addition, the disclosed techniques employ data privacy by hiding certain information from the candidates. For example, a list of the donors associated with a lump sum may be provided to the candidates, but the identity of the Fundraiser may be withheld from the candidate.

The disclosed techniques improve interoperability of disparate systems by allowing an application (e.g., website or stand-alone) operating on a computing device of the user to make a donation to a candidate through the platform via a payment processing application programming interface (API). Also, some embodiments may provide an enhanced graphical user interface that provides a single application that allows a user to set up multiple fundraisers for the same and/or different candidates without having to access other applications. Accordingly, processing and memory resources may be reduced using the single application. The user experience of using a computing device may be enhanced using the improved fundraising and donation techniques employed by the single application connected to the platform because a Fundraiser can easily setup multiple fundraisers (e.g., fundraising pages and/or donation forms) for multiple candidates and donors can easily donate to any candidate they choose to donate to from the single application.

Another benefit provided by the disclosed techniques is that Fundraisers are incentivized to use the platform because the Fundraisers can make a commission off of the donations generated by their fundraising pages. The ability to customize the fundraising pages and/or donation forms however the Fundraiser chooses provides another incentive to use the platform.

Another benefit provide by the disclosed techniques is that it provide a technical platform for upselling certain campaigns. For example, when a Fundraiser creates a fundraising page pertaining to a campaign of a candidate, the platform may use application programming interfaces to share that fundraising page, a reference to that fundraising page, a post pertaining to that fundraising page, a link to that fundraising page, etc. to a social media platform (e.g., FACEBOOK, TWITTER, INSTAGRAM, etc.) or any electronic network. The fundraising page may be posted to any communication platform. The fundraising page may be shared as a link via electronic mail, text message, or the like. The fundraising page may be presented in the social media platform to accounts of people that subscribed to obtain updates pertaining to the candidate, the campaign, etc. In some embodiments, after a certain period of time (threshold period of time), if the people that received the fundraising page on the social media platform(s) did not respond to the fundraising page (e.g., by clicking, selecting, tapping on, etc. the post, notification, link, reference, etc.), the disclosed platform may upsell the fundraising page by providing a notification or causing the fundraising page to be moved to the top of the people's social media platform's user interface feed. Moving the fundraising page to the top of social media platform's user interface feed may refer to “bumping” the fundraising page above other posts, messages, references, etc. In some embodiments, bumping the fundraising page may include reposting the fundraising page in the social media platform, “liking” the fundraising page in the social media platform, commenting on the fundraising page post in the social media platform, or the like.

In some embodiments, the platform may enable contests or competitions for certain candidates. For example, if there are a certain number of Donors that donate an amount of money above a threshold amount, the platform may notify computing devices of those Donors that whoever raises the most money will receive a prize (e.g., monetary amount, gift card, increase commission by a certain amount (e.g., 5%), any benefit or perk, etc.). This may cause the Donors to compete and raise additional funds for the candidate, which in turn causes more use of the platform.

In some embodiments, the disclosed platform may provide templates for candidates to create their own fundraising pages. The fundraising pages created by the candidates may include a direct link or button to enable a user to donate to the campaign. As described herein, various templates may be provided to enable the candidates to configure their fundraising pages. The templates may be presented on computing devices of the candidates via the platform (e.g., a website or application) and the candidates may be enabled to configure the templates (e.g., change configuration of the layout of the fundraising page, color of the fundraising page, graphical user interface elements of the fundraising page, etc.).

In some embodiments, the disclosed techniques may provide a searchable database of candidates that are running. Further, the platform may perform web-crawling of Internet websites pertaining to the candidates and perform screen scraping techniques to obtain information pertaining to the candidates. The information may be public information that is posted on the various websites pertaining to the candidates. The information may include the candidates' name, address, political party, gender, age, sex, reason for running, or any suitable information relevant to participating in a campaign. This information may be correlated with an identity of the candidate in the database and may be used to generate fundraising pages for the candidates. For example, a Fundraiser may select a certain candidate, and the platform may retrieve the information for the candidate and populate a template fundraising page with the information for the candidate. In some embodiments, the information may not be totally complete and the Fundraiser may be enabled to fill in the rest of the information and/or correct the information that is presented. In some embodiments, the information may be totally complete. Such techniques enable generating fundraising pages very quickly, accurately, and may enhance the user's experience of using the computing device because the user does not have to perform searches to find the candidate's information. Such techniques may also reduce computing resources because the user is not using a search engine to perform searches to obtain the candidate's information. Thus, processing and bandwidth resources are reduced because the user is not transmitting requests across a network.

In some embodiments, the platform may generate electronic reports. Any user (e.g., candidate, Donor, Fundraiser, etc.) may enter a candidate's information (e.g., name, age, political party, etc.) and other information (e.g., a certain donation amount, employer, occupation, etc.), and select a graphical user interface element to receive a report of all donors and information pertaining to those donors. Such a report may enable a user to determine who is donating to certain candidates, whether the donations are allowable or violate certain laws, regulations of the like, etc.

In some embodiments, the platform may include a lost-lead tracker that determines when a user (e.g., Donor) begins to fill out information on a fundraising page and then leaves the fundraising page. The lost-lead tracker may determine when a computing device accesses the fundraising page and enters information and then leaves before selecting to submit the information. The lost-lead tracker may obtain the Internet Protocol (IP) address, the geographic location of the user, the name of the user, or any suitable information of the user that began to fill out the fundraising page and may transmit notifications (e.g., emails, text messages, prompts, push notifications, etc.) to a computing device of the user to encourage the user to finish filling out the fundraising pages.

In some embodiments, various data analytics may be performed to track how users are accessing and/or using the various pages disclosed herein (e.g., fundraising page, donation form, etc.). The data analytics may include tracking “clicks” of users on various portions of the pages, the number of viewers or people that accessed the pages, the amount of time the viewers accessed the pages, etc. The data analytics may enable determining, via machine learning or the like, how successful marketing has been of the campaign, what has worked (e.g., what ads were selected, what plans were liked, etc.) and what has not worked, etc.

In some embodiments, the disclosed platform may provide poll analytics. The poll analytics may enable a user to obtain information pertaining to people that are donating to certain candidates. The information may include identities of the people, identities of the candidates to which the people donated money to, demographic information of the donating people, demographic information of the candidates, psychographic information of the people, psychographic information of the candidates, political party information of the candidates and/or the donating people, etc.

In some embodiments, the disclosed platform may perform address validation of Donors to ensure there is no fraudulent activity. For example, if there is a political election in the United States that only allows residents and/or citizens of the United States to vote for the candidates, the platform may determine the citizenship and/or address of a donor (e.g., by checking their citizenship, name, identity, address, IP address, or the like) when the donor attempts to donate money to the campaign of a certain candidate. If the donor is not permitted to donate to the candidate, based on the above determination, the platform will not accept the donation.

In some embodiments, the disclosed techniques may not only be used for raising funds for candidates' campaigns, but may be used for raising funds for any suitable purpose. For example, the techniques may be used for raising funds to post bonds, to start a company, to build an invention, to go to college, etc.

In some embodiments, the disclosed platform may enable electronic disbursement of funds to the various parties involved. For example, various application programming interfaces may be used to connect the platform to various banks systems of the candidates' campaigns, the Fundraisers, etc. to enable the donations to be delivered to certain accounts of the candidate, the campaign, and/or the Fundraiser.

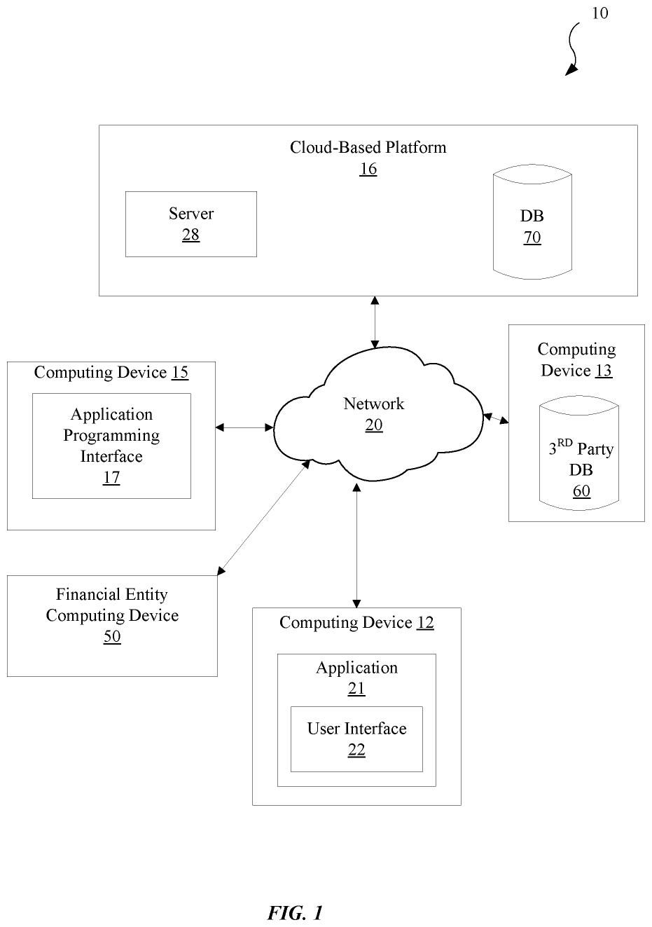

Turning now to the figures, FIG. 1 illustrates a high-level component diagram of an illustrative system architecture 10 according to certain embodiments of this disclosure. In some embodiments, the system architecture 10 may include a computing device 12, a computing device 13, a computing device 15, a financial computing device 50, and a cloud-based platform 16 that may be communicatively coupled via a network 20. As used herein, a cloud-based platform refers, without limitation, to any remote or distal computing system accessed over a network link. The cloud-based platform may include one or more servers 28 and one or more database 70. The server 28 may be a computing device. Each of the computing device 12, computing device 13, computing device 15, the financial entity computing device 50, and/or the server 28 may include one or more processing devices, memory devices, and network interfaces.

The network interfaces may enable communication via a wireless protocol for transmitting data over short distances, such as Bluetooth, ZigBee, near field communication (NFC), etc. Additionally, the network interfaces may enable communicating data over long distances, and in one example, the computing device 12, the computing device 13, the computing device 15, and/or the cloud-based platform 16 may communicate with a network 20. Network 20 may be a public network (e.g., connected to the Internet via wired (Ethernet) or wireless (WiFi)), a private network (e.g., a local area network (LAN), wide area network (WAN), virtual private network (VPN)), or a combination thereof.

The computing device 12 may be any suitable computing device, such as a laptop, tablet, smartphone, or computer. The computing device 12 may be operated by a donor and/or a Fundraiser. The computing device 12 may include a display that is capable of presenting a user interface 22 of an application 21. The application 21 may be implemented in computer instructions stored on the one or more memory devices of the computing device 12 and executable by the one or more processing devices of the computing device 12. The application 21 may be a stand-alone application that is installed on the computing device 12 or may be an application (e.g., website) that executes via a web browser. The user interface 22 may present various screens to a user that enable the user to login, enter personal information (e.g., name; address; employer; age; gender; ethnicity; political party affiliation; etc.), create one or more fundraising pages and donation forms, select a fundraising page to donate an item (e.g., money) to a candidate running for office, and so forth, as described in more detail below.

The computing device 15 may execute an application programming interface 17. The application programming interface 17 may be implemented in computer instructions stored on the one or more memory devices of the computing device 15 and executable by the one or more processing devices of the computing device 15. The application 17 may perform payment processing operations, such as creating a secure communication connection with a financial entity computing device 50, receiving a request from the cloud-based platform 16 to transfer money to from a first account (e.g., a bank account associated with an entity operating the cloud-based platform 16) to a second account (e.g., a bank account of a campaign and/or candidate), transfer the money between the accounts, process refunds when the money is rejected by a candidate, etc. The cloud-based platform 16 may function as a broker for donations from a donor to a candidate via a fundraising page created by a Fundraiser.

The computing device 15 may host and operate a third-party database 60. The third-party database 60 may be stored in a memory device of the computing device 15 and accessed by a processing device of the computing device 13. The third-party database 60 may store any suitable information, such as a contact list for a Fundraiser, a contact list for a donor, and so forth.

In some embodiments, the cloud-based computing system 16 may include the one or more servers 28 that form a distributed, grid, and/or peer-to-peer (P2P) computing architecture. Each of the servers 28 may include one or more processing devices, memory devices, data storage, and/or network interfaces. The servers 28 may be in communication with one another via any suitable communication protocol. The servers 28 may be in communication with the database 70. Although the database 70 is depicted as being separate from the server 28, in some embodiments, the database 70 may be stored in one of the servers 28. The database 70 may store profiles for each of the Fundraisers, donors, and/or candidates. The database 70 may also store information pertaining to which donor donated money, how much money the donor donates, a candidate to which the donor donated money, and so forth. The database 70 may also store self-imposed rules by campaigns for donations, state laws pertaining to donations, federal laws pertaining to donations, campaign financing laws, campaign finance reporting, and so forth.

The database 70 may store computer instructions that implement various fundraising pages and/or donation forms that are created by Fundraisers using the application 21 executing on the computing device 12. The database 70 may store templates for different fundraising pages and/or donation forms. The server 28 may serve the fundraising pages and/or donation forms on demand in the user interface 22 of the application.

In some embodiments, the database 70 of the cloud-based platform 16 does not store bank account information of donors or candidates. The computing device 15 executing the application programming interface 17 may store the bank account information. The computing device 15 may be operated by a payment processing entity (e.g., www.stripe.com, Venmo®).

Donors may make donations of money to their desired campaign and/or candidate using the cloud-based platform 16 via a fundraising page and donation form presented in the user interface 22. The server 28 may receive a request to donate money to a particular candidate and communicate with the application programming interface 17 to transfer the amount of money specified from an account of the donor at a bank via the financial entity computing device 50 to an account associated with the entity operating the cloud-based platform 16. The donations for a particular candidate may be accumulated in the account associated with the entity operating the cloud-based platform 16 for a certain time (e.g., day, week, month, etc.).

The server 28 may determine to transfer the accumulated lump sum of donations for a candidate at the certain time. The server 28 may subtract a commission for the Fundraiser, a processing fee for the entity providing the application programming interface 17, and/or an amount of money for the entity operating the cloud-based platform 16. The resulting lump sum is transferred to an account associated with the candidate and/or campaign.

Also, a list of which donors donated money in the resulting lump sum and how much money each donor donated is transmitted to a computing device operated by a candidate. The candidate may review the list prior to accepting the donations. The candidate may report the list to comply with certain rules and/or laws. In some embodiments, the candidate may determine that they cannot accept the donation (e.g., from a company, the amount exceeds a maximum donation amount for an individual, etc.). In such a case, the candidate may reject a donation and the computing device operated by the candidate may transmit a refund request to the application programming interface 17. The application programming interface 17 may transfer the rejected donation from the account of the entity operating the cloud-based platform 16 back to the account of the donor. A notification may be transmitted by the server 28 to the computing device 12 operated by the donor indicating the donation was refunded and a reason why the donation was rejected.

Further, ata certain time (e.g., day, week, month, etc.) the server 28 may request the application programming interface 17 transfers the commission for the Fundraiser from the account of the entity operating the cloud-based platform 16 to the account of the Fundraiser.

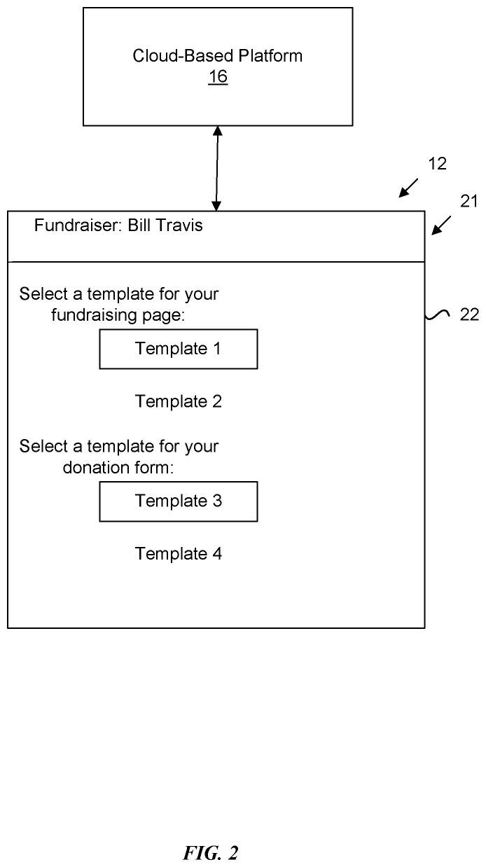

FIG. 2 illustrates an example user interface 22 of the application 21 executing on the computing device 12 that enables a Fundraiser to create a fundraising page and donation form according to certain embodiments of this disclosure. The application 21 may be communicatively coupled to the cloud-based platform 16. A Fundraiser named “Bill Travis” is logged into the application 21. The user interface 22 includes options to select a template for a fundraising page and select a template for a donation form. The templates may include different themes, styles, text format, locations for graphical elements, and so forth. Any suitable number of templates may be provided by the application 21. In some embodiments, an option to create a new template and/or edit a template may be provided in the user interface 22.

The user in the depicted example selected “Template 1” for the fundraising page and “Template 3” for the donation form. The donation form is attached to the fundraising page. The donation form is dynamically created based on information pertaining to a selected candidate and/or campaign for which the Fundraiser desires to raise money. For example, the cloud-based platform 16 may generate the donation form based on state laws where the selected candidate is running a campaign, federal laws that apply to the campaign, etc. There may be certain maximum amounts of money that can be donated by an individual, and those maximum amounts may change between states. Accordingly, the cloud-based platform 16 may determine which maximum amount applies to a campaign and restrict the individual from donating more money than the maximum amount. The cloud-based platform 16 may keep track of identities of donors and how much money they donated to which candidates. In some embodiments, if the donor makes multiple donations to the same candidate, the cloud-based platform 16 may check whether the donor has met the maximum amount yet based on the multiple donations. If the maximum has been met, the cloud-based platform 16 may cause a notification to be presented to the donor indicate such and reject the donation. If the maximum has not been met, the cloud-based platform 16 may allow the donation to be sent to the candidate at the certain time.

In some embodiments, the user interface 22 may present options to enter a reason for creating the fundraising page and/or donation form. The cloud-based platform 16 may receive the reason and natural language processing may be performed to determine if certain keywords, phrases, and the like are included in the reason. For example, derogatory and/or racist motives may be detected based on certain keywords and/or phrases. In some embodiments, the cloud-based platform 16 may reject the creation of the fundraising pages and/or donation forms.

The selection of the templates may cause the application 21 to redirect to another user interface to enable the Fundraiser to customize the selected templates of the fundraising page. In some embodiments, a marketing system may employed using the fundraising page and/or the donation form. For example, during customization of the fundraising page and/or donation form, the Fundraiser may select which social media platforms to enable the fundraising page and/or donation form to be shared. The Fundraiser may select which communication and/or electronic network to share/post the fundraising page and/or donation form to. The Fundraiser may select to allow the fundraising page to be shared to Facebook® and a link may be presented in the fundraising page. When the link is selected by a donor viewing the fundraising page, the fundraising page may be shared to an account of the donor on the Facebook® website or application.

In some embodiments, another marketing system employed by the cloud-based platform 16 may include accessing a contact list of the Fundraiser in the database 70 and/or the third-party database 60 and transmitting links to the fundraising page and/or donation form to the email addresses in the contact list in response to the fundraising form and/or donation form being created.

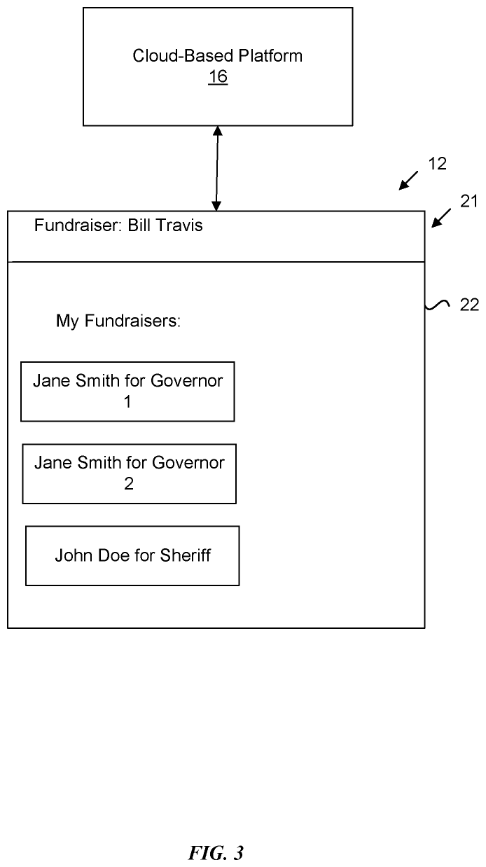

FIG. 3 illustrates an example user interface 22 of an application 12 executing on the computing device 12 presenting a home page for a Fundraiser according to certain embodiments of this disclosure. The home page depicts a list of the fundraising pages “Bill Travis” created. As depicted, the user interface 22 includes links to fundraising pages “Jane Smith for Governor 1”, “Jane Smith for Governor 2”, and “John Doe for Sheriff”. As depicted, different fundraising pages (e.g., “Jane Smith for Governor 1” and “Jane Smith for Governor 2”) may be created for the same candidate and each one can be tailored with a different “spin”.

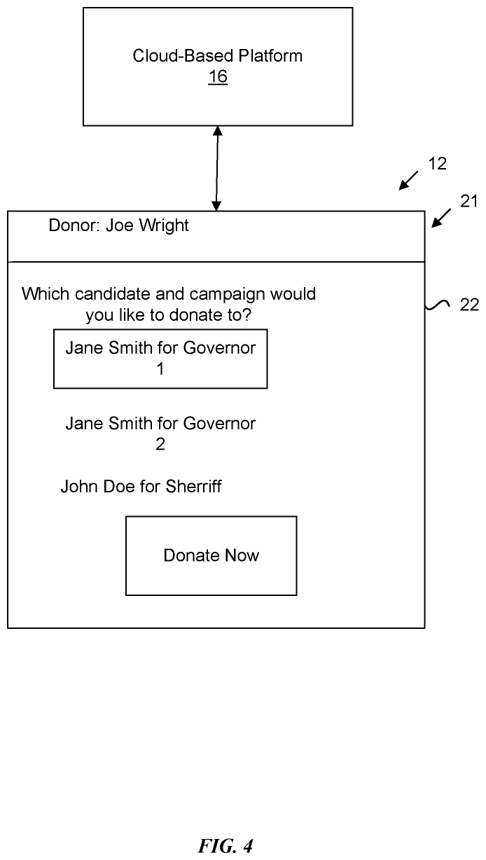

FIG. 4 illustrates an example user interface 22 of an application 12 executing on the computing device 12 presenting a fundraising page to a donor according to certain embodiments of this disclosure. The donor “Joe Wright” is logged into the application 21. The user interface 22 presents a graphical element (e.g., button) to “Donate Now”. The user interface 22 presents available fundraising pages that are created in the cloud-based platform 16. The donor has selected the fundraising page “Jane Smith for Governor 1”. Further, the user selected the “Donate Now” button. Selection of the “Donate Now” button may redirect the user interface 22 to a donation form specifically tailored for the particular campaign of the candidate.

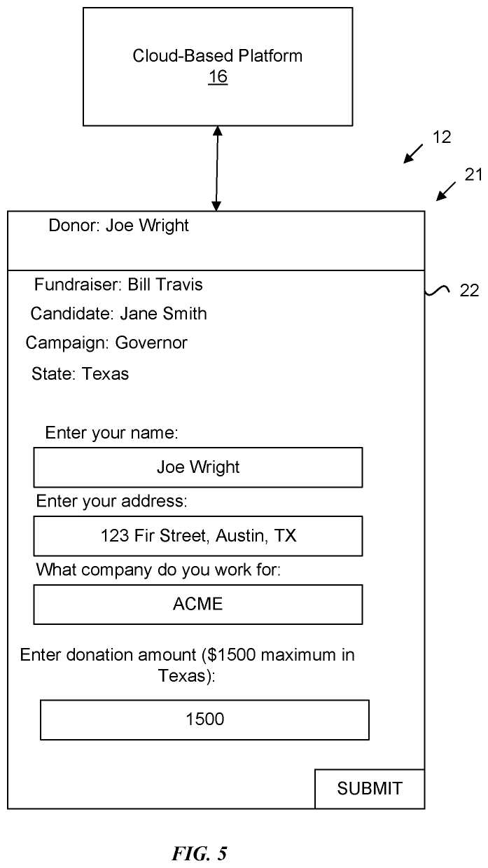

For example, FIG. 5 illustrates an example user interface 22 of an application 21 executing on the computing device 21 presenting a donation form according to certain embodiments of this disclosure. The donation form presents various information, including an identity of a Fundraiser (“Bill Travis”), an identity of the candidate (“Jane Smith”), the campaign (“Governor”), and the state (“Texas”). Further, the user interface 22 also includes input graphical elements for “Enter your name”, “Enter your address”, “What company do you work for”, and “Enter donation amount ($1500 maximum in Texas)”. It should be noted that the donation form is electronically generated by the cloud-based platform 16. For example, the cloud-based platform 16 may determine the applicable laws and/or rules for the location of the campaign. For example, the campaign finance reporting laws may indicate that certain information is required to be obtained from a donor, and the donation form may be generated to request that information from the donor. Also, certain states may allow a maximum amount of money to be donated by an individual, and the donation form may specify that maximum amount of money. There may be restrictions implemented by the donation form that prevent the user from donating more than the maximum amount of money (e.g., $1500). The donor may select the “SUBMIT” button to transmit a donation request to the cloud-based platform 16.

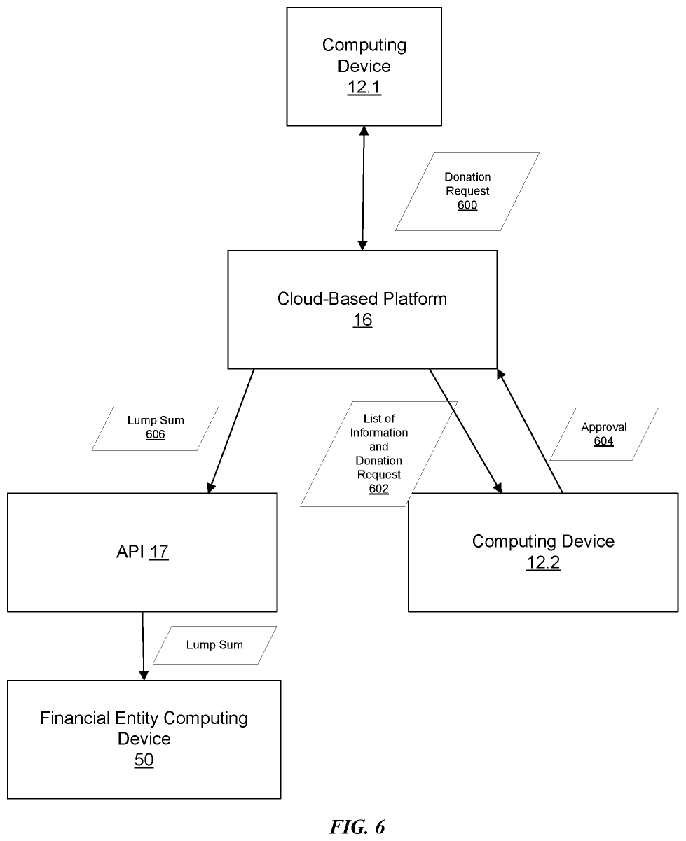

FIG. 6 illustrates an example block diagram of various operations performed by components of the system according to certain embodiments of this disclosure. As depicted, a donor used the computing device 12.1 to transmit a donation request 600 to the cloud-based platform 16. The donation request 600 may include an amount of money to donate, a candidate to donate the money to, the identity of the donor, and so forth. The cloud-based platform 16 may accumulate numerous amounts of money from numerous donation requests and store the information in the database 70. Further, the cloud-based platform 16 may request the API 17 communicate with the financial entity computing device 50 to transfer the amounts of money from accounts of the donors to the account of the entity operating the cloud-based platform 16.

The cloud-based platform 16 may subtract a commission fee for the Fundraiser that created the fundraising page, a processing fee for the entity operating the API 17, a fee for the entity that operates the cloud-based platform 16 to obtain a lump sum of the money for the candidate.

At a certain time, the cloud-based platform 16 transmit a list of information and the donation request(s) 602 to the computing device 12.2 operated by a candidate. The list of information may include itemized list of all the donors included in the donation requests, as well as the amount of money each donor is donating. The candidate may review the list and determine whether it complies with the various laws and rules of the campaign and/or government (e.g., state/federal). If it complies for reporting purposes, the campaign may approve the donations (approval message 604). The approval message 604 may be transmitted to the cloud-based platform 16. The cloud-based platform 16 may transmit a message to the API 17 to transfer the lump sum 606 from an account of the entity operating the cloud-based platform 16 to an account of the candidate and/or campaign via the financial entity computing device 50.

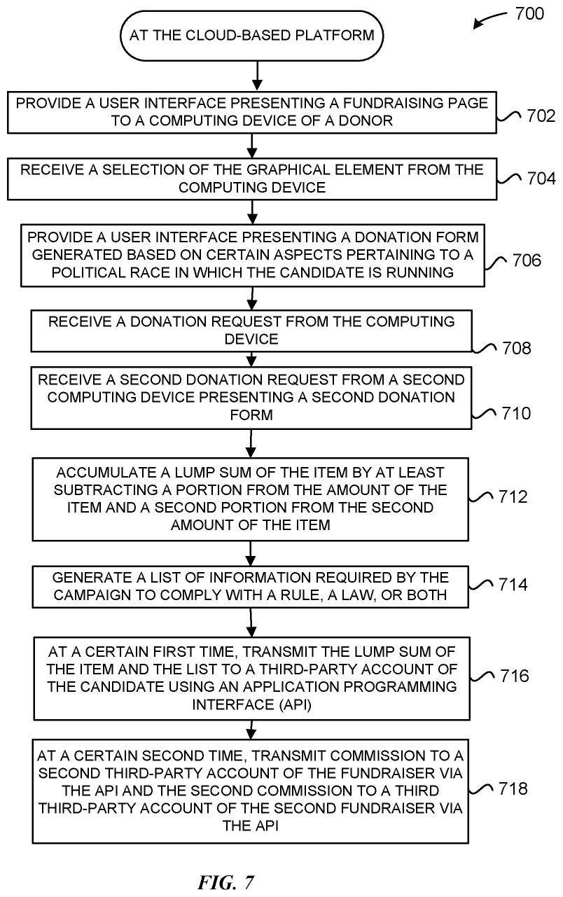

FIG. 7 illustrates example operations of a method 700 for enabling a donor to donate to a candidate. The method 700 may be performed by processing logic that may include hardware (circuitry, dedicated logic, etc.), firmware, software, or a combination of them. The method 700 and/or each of their individual functions, subroutines, or operations may be performed by one or more processing devices included in a computing device (e.g., server 28, computing device 12, computing device 13, computing device 15, and/or financial entity computing device 50 of FIG. 1) implementing the method 700. The method 700 may be implemented as computer instructions executable by a processing device of the control system. In certain implementations, the method 700 may be performed by a single processing thread. Alternatively, the method 700 may be performed by two or more processing threads, each thread implementing one or more individual functions, routines, subroutines, or operations of the methods.

At block 702, the processing device may provide a user interface presenting a fundraising page to a computing device of a donor. The fundraising page may include a graphical element to enable donating to a candidate and the fundraising page may be generated based on a first template selected by a fundraiser. The graphical element may be a “Donate Now” button. The first template may be selected from a set of templates including different themes, styles, color choices, locations for graphical elements (e.g., buttons, input boxes, sliders, etc.), locations for text, locations for images, and/or locations for videos.

At block 704, the processing device may receive a selection of the graphical element from the computing device. The graphical element may be the “Donate Now” button.

At block 706, the processing device may provide a user interface presenting a donation form generated based on certain aspects pertaining to a political race in which the candidate is running, a government for which the political race is being held, or some combination thereof. The donation form may be generated based on a second template. The second template may be selected from a set of second templates, where each second template includes a different theme, color choices, locations for graphical elements (e.g., buttons, input boxes, sliders, etc.), locations for text, locations for images, and/or locations for videos. In some embodiments, the second templates may include corresponding themes and/or styles to respective first templates.

At block 708, the processing device may receive a donation request from the computing device. The donation request may include an amount of an item (e.g., money) to donate, an identity of the candidate, and/or a campaign associated with the candidate.

At block 710, the processing device may receive a second donation request from a second computing device presenting a second donation form. The second donation request may include a second amount of the item to donate, the identity of the candidate, and the campaign associated with the candidate.

At block 712, the processing device may accumulate a lump sum of the item by at least subtracting a portion from the amount of the item and a second portion from the second amount of the item. The portion from the amount of the item is a commission for a fundraiser associated with the donation form, and the second portion from the second amount of item is a second commission for a second fundraiser associated with the second donation form. Other portions may be subtracted from the amount of the item, such as a processing fee for an entity of the API and a fee for the entity operating the cloud-based platform.

At block 714, the processing device may generate a list of information required by the campaign to comply with a rule, a law, or both. The list of information may include at least an identity of the donor, an amount of the item being donated, a company for which the donor works, an address of the donor, whether the donation is at a maximum donation value for the donor, or some combination thereof.

At block 716, at a certain first time, the processing device may transmit the lump sum of the item and the list to a third-party account of the candidate via an application programming interface (API).

At block 718, at a certain second time, the processing device may transmit, via the API, the commission to a second third-party account of the fundraiser and the second commission to a third third-party account of the second fundraiser.

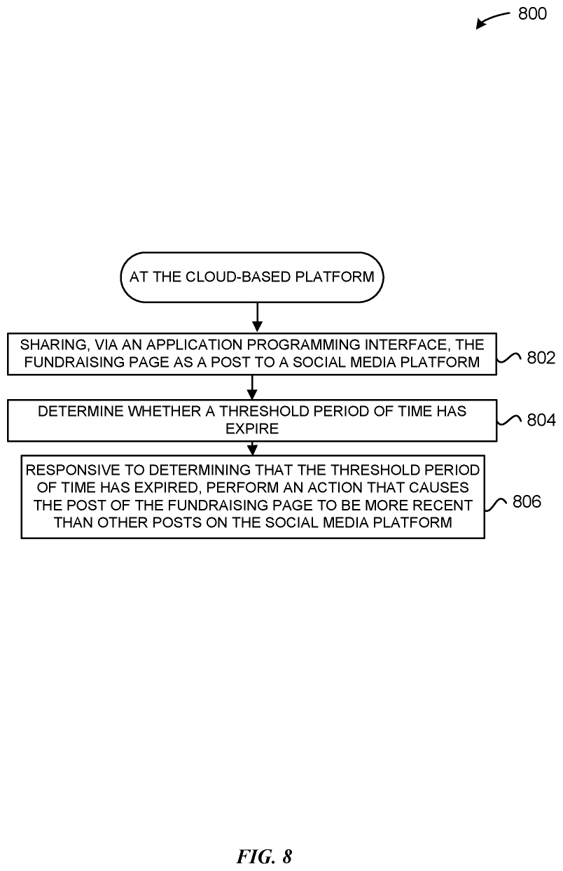

FIG. 8 illustrates example operations of a method 800 for upselling a fundraising page on a social media platform according to certain embodiments of this disclosure. The method 800 may be performed by processing logic that may include hardware (circuitry, dedicated logic, etc.), firmware, software, or a combination of them. The method 800 and/or each of their individual functions, subroutines, or operations may be performed by one or more processing devices included in a computing device (e.g., server 28, computing device 12, computing device 13, computing device 15, and/or financial entity computing device 50 of FIG. 1) implementing the method 800. The method 800 may be implemented as computer instructions executable by a processing device of the control system. In certain implementations, the method 800 may be performed by a single processing thread. Alternatively, the method 800 may be performed by two or more processing threads, each thread implementing one or more individual functions, routines, subroutines, or operations of the methods.

At block 802, the processing device share, via an application programming interface, a fundraising page (e.g., generated by a Fundraiser, a candidate, or any suitable person using a template provided by the disclosed platform) as a post to a social media platform.

At block 804, the processing device may determine whether a threshold period of time has expired. The threshold period of time may be configurable and may be any suitable amount of time (e.g., minutes, hours, days, etc.).

At block 806, responsive to determining that the threshold period of time has expired, the processing device may perform an action that causes the post of the fundraising page to be more recent than other posts on the social media platform. For example, the fundraising page may be moved or reposted higher than other posts in a feed of a social media platform for any user who has an account registered with the social media platform and has subscribed or chosen to follow the candidate, the campaign of the candidate, the fundraising page, etc.

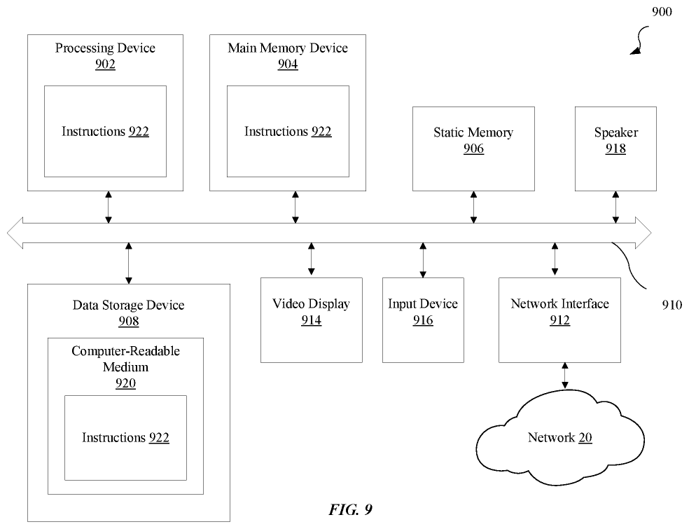

FIG. 9 illustrates an example computer system 900, which can perform any one or more of the methods described herein. In one example, computer system 900 may correspond to the computing device 12, the computing device 15, the computing device 13, the financial entity computing device 50, or any component in the cloud-based platform 16 (e.g., server 28) of FIG. 1. The computer system 900 may be capable of executing the application 21 and presenting the user interface 22 of FIG. 1, the executing the application programming interface 17, and/or executing the third-party database 60 of FIG. 1. The computer system 900 may be connected (e.g., networked) to other computer systems in a LAN, an intranet, an extranet, or the Internet. The computer system 900 may operate in the capacity of a server in a client-server network environment. The computer system 900 may be a personal computer (PC), a tablet computer, a wearable (e.g., wristband), a set-top box (STB), a personal Digital Assistant (PDA), a mobile phone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The computer system 900 includes a processing device 902, a main memory device 904 (e.g., read-only memory (ROM), solid state drive (SSD), flash memory, dynamic random access memory (DRAM) such as synchronous DRAM (SDRAM)), a static memory 906 (e.g., solid state drive (SSD), flash memory, static random access memory (SRAM)), and a data storage device 908, which communicate with each other via a bus 910.

Processing device 902 represents one or more general-purpose processing devices such as a microprocessor, central processing unit, or the like. More particularly, the processing device 902 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 902 may also be one or more special-purpose processing devices such as an application specific integrated circuit (ASIC), a field programmable gate array (FPGA), a digital signal processor (DSP), network processor, or the like. The processing device 902 is configured to execute instructions for performing any of the operations and steps discussed herein.

The computer system 900 may further include a network interface 912. The computer system 900 also may include a video display 914 (e.g., a liquid crystal display (LCD) or a cathode ray tube (CRT)), one or more input devices 916 (e.g., a keyboard and/or a mouse), and one or more speakers 918 (e.g., a speaker). In one illustrative example, the video display 914 and the input device(s) 916 may be combined into a single component or device (e.g., an LCD touch screen).

The data storage device 916 may include a computer-readable medium 920 on which the instructions 922 embodying any one or more of the methodologies or functions described herein are stored. The instructions 922 may also reside, completely or at least partially, within the main memory device 904 and/or within the processing device 902 during execution thereof by the computer system 900. As such, the main memory device 904 and the processing device 902 also constitute computer-readable media. The instructions 922 may further be transmitted or received over a network via the network interface 912.

While the computer-readable storage medium 920 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Clauses:

1. A method comprising:

providing a user interface presenting a fundraising page to a computing device of a donor, wherein the fundraising page includes a graphical element to enable donating to a candidate and the fundraising page is generated based on a first template;

receiving a selection of the graphical element from the computing device;

providing a user interface presenting a donation form generated based on a second template;

receiving a donation request from the computing device, the donation request comprising an amount of an item to donate, an identity of the candidate, and a campaign associated with the candidate;

receiving a second donation request from a second computing device presenting a second donation form, the second donation request comprising a second amount of the item to donate, the identity of the candidate, and the campaign associated with the candidate;

accumulating a lump sum of the item;

generating a list of information required by the campaign to comply with a rule, a law, a regulation, or some combination thereof;

at a certain first time, transmitting the lump sum of the item and the list to a third-party account of the candidate via an application programming interface (API); and

at a certain second time, transmitting, via the API, the commission to a second third-party account of the fundraiser and the second commission to a third third-party account of the second fundraiser.

2. The method of clause 1, wherein the donation form is generated based on certain aspects pertaining to a political race in which the candidate is running, a government for which the political race is being held, or some combination thereof.

3. The method of clause 1, wherein the lump sum is generated by at least subtracting a portion from the amount of the item and a second portion from the second amount of the item, wherein the portion from the amount of the item comprises a commission for a fundraiser associated with the donation form, and the second portion from the second amount of item comprise a second commission for a second fundraiser associated with the second donation form.

4. The method of clause 1, wherein the list of information comprises at least an identity of the donor.

5. The method of clause 1, wherein:

the certain first time is based on a predetermined time interval, a certain sum of donations, or both; and

the certain second time is based on a predetermined time interval, a certain sum of commissions, or both.

6. The method of clause 1, further comprising sharing, via an application programming interface, the fundraising page as a post to a social media platform.

7. The method of clause 6, further comprising:

determining whether a threshold period of time has expired; and

responsive to determining that the threshold period of time has expired, performing an action that causes the post of the fundraising page to be more recent than other posts on the social media platform.

8. A non-transitory, tangible computer-readable medium storing instructions that, when executed, cause a processing to:

provide a user interface presenting a fundraising page to a computing device of a donor, wherein the fundraising page includes a graphical element to enable donating to a candidate and the fundraising page is generated based on a first template;

receive a selection of the graphical element from the computing device;

provide a user interface presenting a donation form generated based on a second template;

receive a donation request from the computing device, the donation request comprising an amount of an item to donate, an identity of the candidate, and a campaign associated with the candidate;

receive a second donation request from a second computing device presenting a second donation form, the second donation request comprising a second amount of the item to donate, the identity of the candidate, and the campaign associated with the candidate;

accumulate a lump sum of the item;

generate a list of information required by the campaign to comply with a rule, a law, a regulation, or some combination thereof;

at a certain first time, transmit the lump sum of the item and the list to a third-party account of the candidate via an application programming interface (API); and

at a certain second time, transmit, via the API, the commission to a second third-party account of the fundraiser and the second commission to a third third-party account of the second fundraiser.

9. The computer-readable medium of clause 8, wherein the donation form is generated based on certain aspects pertaining to a political race in which the candidate is running, a government for which the political race is being held, or some combination thereof.

10. The computer-readable medium of clause 8, wherein the lump sum is generated by at least subtracting a portion from the amount of the item and a second portion from the second amount of the item, wherein the portion from the amount of the item comprises a commission for a fundraiser associated with the donation form, and the second portion from the second amount of item comprise a second commission for a second fundraiser associated with the second donation form.

11. The computer-readable medium of clause 8, wherein the list of information comprises at least an identity of the donor.

12. The computer-readable medium of clause 8, wherein:

the certain first time is based on a predetermined time interval, a certain sum of donations, or both; and

the certain second time is based on a predetermined time interval, a certain sum of commissions, or both.

13. The computer-readable medium of clause 8, wherein the processing device is further to share, via an application programming interface, the fundraising page as a post to a social media platform.

14. The method of clause 13, wherein the processing device is further to:

determine whether a threshold period of time has expired; and

responsive to determining that the threshold period of time has expired, perform an action that causes the post of the fundraising page to be more recent than other posts on the social media platform.

15. A system comprising:

a memory device storing instructions; and

a processing device communicatively coupled to the memory device, the processing device executes the instructions to:

provide a user interface presenting a fundraising page to a computing device of a donor, wherein the fundraising page includes a graphical element to enable donating to a candidate and the fundraising page is generated based on a first template;

receive a selection of the graphical element from the computing device;

provide a user interface presenting a donation form generated based on a second template;

receive a donation request from the computing device, the donation request comprising an amount of an item to donate, an identity of the candidate, and a campaign associated with the candidate;

receive a second donation request from a second computing device presenting a second donation form, the second donation request comprising a second amount of the item to donate, the identity of the candidate, and the campaign associated with the candidate;

accumulate a lump sum of the item;

generate a list of information required by the campaign to comply with a rule, a law, a regulation, or some combination thereof;

at a certain first time, transmit the lump sum of the item and the list to a third-party account of the candidate via an application programming interface (API); and

at a certain second time, transmit, via the API, the commission to a second third-party account of the fundraiser and the second commission to a third third-party account of the second fundraiser.

16. The system of clause 15, wherein the donation form is generated based on certain aspects pertaining to a political race in which the candidate is running, a government for which the political race is being held, or some combination thereof.

17. The system of clause 15, wherein the lump sum is generated by at least subtracting a portion from the amount of the item and a second portion from the second amount of the item, wherein the portion from the amount of the item comprises a commission for a fundraiser associated with the donation form, and the second portion from the second amount of item comprise a second commission for a second fundraiser associated with the second donation form.

18. The system of clause 15, wherein the list of information comprises at least an identity of the donor.

19. The system of clause 15, wherein:

the certain first time is based on a predetermined time interval, a certain sum of donations, or both; and

the certain second time is based on a predetermined time interval, a certain sum of commissions, or both.

20. The system of clause 15, wherein the processing device is further to:

share, via an application programming interface, the fundraising page as a post to a social media platform;

determine whether a threshold period of time has expired; and

responsive to determining that the threshold period of time has expired, perform an action that causes the post of the fundraising page to be more recent than other posts on the social media platform.

The various aspects, embodiments, implementations or features of the described embodiments can be used separately or in any combination. The embodiments disclosed herein are modular in nature and can be used in conjunction with or coupled to other embodiments, including both statically-based and dynamically-based equipment. In addition, the embodiments disclosed herein can employ selected equipment such that they can identify individual users and auto-calibrate threshold multiple-of-body-weight targets, as well as other individualized parameters, for individual users.

The foregoing description, for purposes of explanation, used specific nomenclature to provide a thorough understanding of the described embodiments. However, it should be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It should be apparent to one of ordinary skill in the art that many modifications and variations are possible in view of the above teachings.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

What is claimed is:

1. A method comprising:
providing a user interface presenting a fundraising page to a computing device of a donor, wherein the fundraising page includes a graphical element to enable donating to a candidate and the fundraising page is generated based on a first template;
receiving a selection of the graphical element from the computing device;
providing a user interface presenting a donation form generated based on a second template;
receiving a donation request from the computing device, the donation request comprising an amount of an item to donate, an identity of the candidate, and a campaign associated with the candidate;
receiving a second donation request from a second computing device presenting a second donation form, the second donation request comprising a second amount of the item to donate, the identity of the candidate, and the campaign associated with the candidate;
accumulating a lump sum of the item;
generating a list of information required by the campaign to comply with a rule, a law, a regulation, or some combination thereof;
at a certain first time, transmitting the lump sum of the item and the list to a third-party account of the candidate via an application programming interface (API); and
at a certain second time, transmitting, via the API, the commission to a second third-party account of the fundraiser and the second commission to a third third-party account of the second fundraiser.

2. The method of claim 1, wherein the donation form is generated based on certain aspects pertaining to a political race in which the candidate is running, a government for which the political race is being held, or some combination thereof.

3. The method of claim 1, wherein the lump sum is generated by at least subtracting a portion from the amount of the item and a second portion from the second amount of the item, wherein the portion from the amount of the item comprises a commission for a fundraiser associated with the donation form, and the second portion from the second amount of item comprise a second commission for a second fundraiser associated with the second donation form.

4. The method of claim 1, wherein the list of information comprises at least an identity of the donor.

5. The method of claim 1, wherein:
the certain first time is based on a predetermined time interval, a certain sum of donations, or both; and
the certain second time is based on a predetermined time interval, a certain sum of commissions, or both.

6. The method of claim 1, further comprising sharing, via an application programming interface, the fundraising page as a post to a social media platform.

7. The method of claim 6, further comprising:
determining whether a threshold period of time has expired; and
responsive to determining that the threshold period of time has expired, performing an action that causes the post of the fundraising page to be more recent than other posts on the social media platform.

8. A non-transitory, tangible computer-readable medium storing instructions that, when executed, cause a processing to:
provide a user interface presenting a fundraising page to a computing device of a donor, wherein the fundraising page includes a graphical element to enable donating to a candidate and the fundraising page is generated based on a first template;
receive a selection of the graphical element from the computing device;
provide a user interface presenting a donation form generated based on a second template;
receive a donation request from the computing device, the donation request comprising an amount of an item to donate, an identity of the candidate, and a campaign associated with the candidate;
receive a second donation request from a second computing device presenting a second donation form, the second donation request comprising a second amount of the item to donate, the identity of the candidate, and the campaign associated with the candidate;
accumulate a lump sum of the item;
generate a list of information required by the campaign to comply with a rule, a law, a regulation, or some combination thereof;
at a certain first time, transmit the lump sum of the item and the list to a third-party account of the candidate via an application programming interface (API); and
at a certain second time, transmit, via the API, the commission to a second third-party account of the fundraiser and the second commission to a third third-party account of the second fundraiser.

9. The computer-readable medium of claim 8, wherein the donation form is generated based on certain aspects pertaining to a political race in which the candidate is running, a government for which the political race is being held, or some combination thereof.

10. The computer-readable medium of claim 8, wherein the lump sum is generated by at least subtracting a portion from the amount of the item and a second portion from the second amount of the item, wherein the portion from the amount of the item comprises a commission for a fundraiser associated with the donation form, and the second portion from the second amount of item comprise a second commission for a second fundraiser associated with the second donation form.

11. The computer-readable medium of claim 8, wherein the list of information comprises at least an identity of the donor.

12. The computer-readable medium of claim 8, wherein:
the certain first time is based on a predetermined time interval, a certain sum of donations, or both; and
the certain second time is based on a predetermined time interval, a certain sum of commissions, or both.

13. The computer-readable medium of claim 8, wherein the processing device is further to share, via an application programming interface, the fundraising page as a post to a social media platform.

14. The method of claim 13, wherein the processing device is further to:
determine whether a threshold period of time has expired; and
responsive to determining that the threshold period of time has expired, perform an action that causes the post of the fundraising page to be more recent than other posts on the social media platform.

15. A system comprising:
a memory device storing instructions; and
a processing device communicatively coupled to the memory device, the processing device executes the instructions to:
provide a user interface presenting a fundraising page to a computing device of a donor, wherein the fundraising page includes a graphical element to enable donating to a candidate and the fundraising page is generated based on a first template;
receive a selection of the graphical element from the computing device;
provide a user interface presenting a donation form generated based on a second template;
receive a donation request from the computing device, the donation request comprising an amount of an item to donate, an identity of the candidate, and a campaign associated with the candidate;
receive a second donation request from a second computing device presenting a second donation form, the second donation request comprising a second amount of the item to donate, the identity of the candidate, and the campaign associated with the candidate;
accumulate a lump sum of the item;
generate a list of information required by the campaign to comply with a rule, a law, a regulation, or some combination thereof;
at a certain first time, transmit the lump sum of the item and the list to a third-party account of the candidate via an application programming interface (API); and
at a certain second time, transmit, via the API, the commission to a second third-party account of the fundraiser and the second commission to a third third-party account of the second fundraiser.

16. The system of claim 15, wherein the donation form is generated based on certain aspects pertaining to a political race in which the candidate is running, a government for which the political race is being held, or some combination thereof.

17. The system of claim 15, wherein the lump sum is generated by at least subtracting a portion from the amount of the item and a second portion from the second amount of the item, wherein the portion from the amount of the item comprises a commission for a fundraiser associated with the donation form, and the second portion from the second amount of item comprise a second commission for a second fundraiser associated with the second donation form.

18. The system of claim 15, wherein the list of information comprises at least an identity of the donor.

19. The system of claim 15, wherein:
the certain first time is based on a predetermined time interval, a certain sum of donations, or both; and
the certain second time is based on a predetermined time interval, a certain sum of commissions, or both.

20. The system of claim 15, wherein the processing device is further to:
share, via an application programming interface, the fundraising page as a post to a social media platform;
determine whether a threshold period of time has expired; and
responsive to determining that the threshold period of time has expired, perform an action that causes the post of the fundraising page to be more recent than other posts on the social media platform.
